(19) United States
(12) Patent Application Publication
(10) Pub. No.: US 2009/0171814 A1
(43) Pub. Date: Jul. 2, 2009

(54) REMOTE WAREHOUSE MANAGEMENT SYSTEM

(75) Inventor: Liying GENG, Beijing (CN)

Correspondence Address: YING CHEN;Chen Yoshimura LLP, 255 S. GRAND AVE., # 215, LOS ANGELES, CA, 90012, US

(73) Assignee: Beijing Aotengxunda Science and Technology Co., Ltd, Beijing (CN)

(21) Appl. No.: 12/118,305

(22) Filed: May 9, 2008

(30) Foreign Application Priority Data
Dec. 27, 2007 (CN) 200710304390.1

(51) Int. Cl. G06Q 10/00; G06F 17/30; G06F 15/16

(52) U.S. Cl. 705/28

(57) ABSTRACT

The invention relates to a remote warehouse management system comprising a central processing system and one or more remote data collection terminals, which exchange data with the central processing system, wherein each of the remote data collection terminals includes a wireless transceiver module which conducts wireless communication with the central processing system through a wireless base station, wherein the central processing system includes a matched wireless transceiver module which receives entry-exit data of various goods delivered by the data collection terminals through the wireless base station, wherein the central processing system making statistics and analyzes on the entry-exit data received and making them stored. This system can not only collect and process data automatically but also optimize the stock mode, stock balance and stock time of goods according to the enterprise's operating conditions.

### BACKGROUND OF THE INVENTION

1. Field of the Invention

The invention relates to a remote warehouse management system and pertains to the field of computer information technology.

2. Description of the Related Art

At present, there are various kinds of remote warehouse management systems, essentially comprise a central processing system and a plurality of remote data collection terminals exchanging data with the central processing system. The plurality of remote data collection terminals collect warehouse entry-exit data and the central processing system make a statistics on the data and then storage the results, thereby enabling people to link up the warehousing conditions of various goods at any moment. Even though different systems focus on different managerial requirements and have various different characteristics owing to that different designers are guided by different ideologies and goals, the exited systems usually can only reduce workload and working hours by collecting and processing data automatically but can not optimize and control the stock mode, stock balance and stock time of goods with regard to the enterprise's overall economic benefits.

### SUMMARY OF THE INVENTION

In order to overcome the said defects in the prior art, the invention provides a remote warehouse management system, which can not only collect and process data automatically but also optimize the stock mode, stock balance and stock time of goods according to the enterprise's operating conditions.

The technical solution of the invention to realize the said goals is: a remote warehouse management system mainly comprises a central processing system and one or more remote data collection terminals exchanging data with the central processing system, wherein, the remote data collection terminal includes a wireless transceiver module, which conducts wireless communication with the central processing system through a wireless base station, wherein the central processing system includes a matched wireless transceiver module, which receives entry-exit data of various goods delivered by the data collection terminals through the wireless base station, makes statistics and analyzes of the entry-exit data and stores it. The said central processing system includes a real-time stock database, a stock optimization database, a data statistics unit, a data comparison and analysis unit, a data storage and output unit, a manual input device and a central control unit, wherein the data statistics unit is used for acquiring the entry-exit data of various goods collected by the data terminal, reading the corresponding data in the real-time stock database and making statistics and calculation of the data and acquiring stock balance data, entry-exit time data and characteristic data, etc. of various goods, as well as sending these data into the real-time stock database for storage through the data storage and output unit; wherein the data comparison and analysis unit is used for reading the stock balance data, the entry-exit time data and the characteristic data of various goods in the real-time stock database, reading the optimization program and optimization parameters in the stock optimization data, and conducting optimization calculation, as well as generating a stock excess signal within a time limit if the stock balance of certain goods is above the upper limit of the optimal stock balance, a stock shortage signal within a timeframe if the stock balance of certain goods is below the lower limit of the optimal stock balance, and a stock time warning signal if the stock time of certain goods reaches the warning amount, and for storing the signals in the stock optimization database and giving warning display through the data storage and output unit, wherein the data storage and output unit is used for receiving data from the data statistics unit, the data comparison and analysis unit and the manual input device and sending such data into the related database for storage, or reading data of the corresponding database according to self data statistics unit, the data comparison and analysis unit and the manual input device, and giving the data display; and the central control unit is used for controlling coordination work among the data statistics unit, the data comparison and analysis unit, the data storage and output unit and the manual input unit.

Owing to that the system is mainly based on two aspects, namely, automation and optimization of an enterprise warehouse, it can not only realize the automation of general warehouse management system, but also make optimization analysis on the stock, and conduct optimization control upon the stock balance and the stock time, as well as give a warning when the stock is in excess or shortage or certain goods are stored too long, and remind the managerial personnel to handle the problem in time, and thereby raising the enterprise operating and managerial level as a whole, lowering the warehousing cost and risk and reducing the overstocking of capital. Owing to that the stock optimization mode can be timely adjusted and amended based on the manual input, the optimization mode can be changed at any time when changes occurred in the enterprise internal management or external market conditions to achieve best optimization effects. In addition, the requirements on hardware required by the management system is simple, with low investment cost, high automation degree and excellent adaptability, which can utilize the entry-exit data to make automatic optimization analysis, and therefore does not increase the workload of the operators and is favorable for its popularization and application.

### BRIEF DESCRIPTION OF THE DRAWING

FIG. 1 is a schematic view of an embodiment of the invention.

### DETAILED DESCRIPTION OF THE PREFERRED EMBODIMENTS

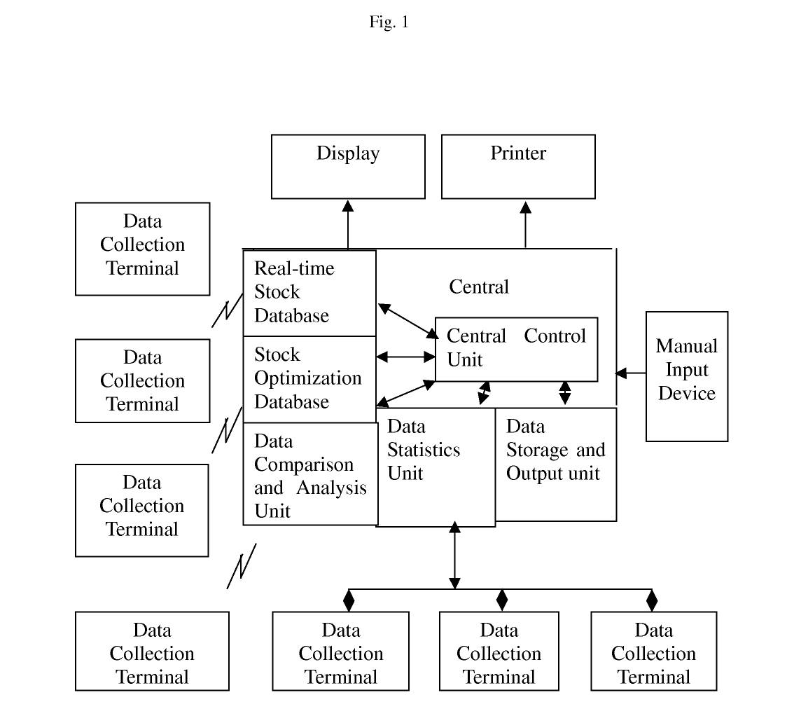

With reference to FIG. 1, the invention provides a remote warehouse management system, which mainly comprises a central processing system and one or more remote data collection terminals conducting data exchange with the central processing system. Wherein, the remote data collection terminal includes a wireless transceiver module, which conducts wireless communication with the central processing system through a wireless base station, wherein the central processing system includes a matched wireless transceiver module, which receives the entry-exit data of various goods delivered by the data collection terminal through the wireless base station, and make statistics and analyzes the entry-exit data and stores it. The said central processing system includes a real-time stock database and a stock optimization database, as well as a data statistics unit, a data comparison and analysis unit, a data storage and output unit and a manual input device and a central control unit. Wherein, the data statistics unit is used for acquiring the entry-exit data of various goods collected by the data terminal, reading the corresponding data in the real-time stock database and making statistics and calculation, and acquiring the stock balance data, the entry-exit time data and the characteristic data, etc. of various goods, as well as sending these data into the real-time stock database for storage through the data storage and output unit, wherein the data comparison and analysis unit is used for reading the stock balance data, the entry-exit time data and characteristic data of various goods in the real-time stock database, reading the optimization program and optimization parameters in the stock optimization data, and conducting optimization calculation, as well as for generating a stock excess signal within a timeframe if the stock balance of certain goods is above the upper limit of the optimal stock balance, a stock shortage signal within a timeframe if the stock balance of certain goods is below the lower limit of the optimal stock balance, and a stock time warning signal if the stock time of certain goods reaches the warning amount, and for storing the signal in the stock optimization database and giving warning display through the data storage and output unit, wherein the data storage and output unit is used for receiving data from the data statistics unit, the data comparison and analysis unit and the manual input device and sending such data into the related database for storage, or reading data of the corresponding database according to instruction from the data statistics unit, the data comparison and/or the analysis unit and manual input device, and giving the data display, wherein the central control unit is used for controlling the coordination work among the data statistics data, the data comparison and analysis unit, the data storage and output unit and the manual input unit.

The system takes the computer information processing as a major management tool to conduct automatic management upon the warehousing of various kinds of enterprises, especially large-sized industrial enterprises and commercial enterprises. The hardware part of the computer system includes a plurality of remote and local data collection terminals of entry-exit goods and a central processing system, with freight areas of the warehouse being divided into a plurality of partitions. Wherein, the remote data collection terminals of entry-exit goods are used for collecting the information of goods of entry or exit, and sending the collected goods information to the central processing system. When goods entering the warehouse, the central processing system, supported by the categorical database and the real-time stock database, confirms the deposit area of the entered goods, allocates the fright lot for storage, sends goods storage instruction to operating personnel or an auto-transmitter, and records the entered goods data into the real-time stock database; when goods exiting from the warehouse, the exit instruction will be input manually or mechanically to the central processing system, which reads the data from the real-time stock database, confirms the freight lot for goods according to the mode of “first-in first-out”, and sends the goods withdrawal instruction to the operating personnel or the auto-transmitter, as well as records the exited goods data sent from the remote data collection terminals in the real-time stock database; the data collection of entry-exit goods is made by a mobile or fixed bar code recognizer or by manual output mode to do the collection according to the actual conditions of various goods, and the mobile bar code recognizer is a mobile bar code recognizer which communicates with the central processing system according to the actual conditions through either wired or wireless mode; the mobile bar code recognizer includes a display screen for displaying the read bar code information and the stock management information, and with a manual input device for manual output of information; each data collection terminal also comprises a network controller, which communicates with the central processing system and the bar code recognizer through either wired or wireless mode, transfers the information sent by the central processing system to the bar code recognizer and transfers the information collected by the bar code recognizer to the central processing system; the network controller includes a wired network connection port, and the central processing system is linked up through the port and the wired network, and thereby converting and optimizing the protocol of the central processing system and the bar code recognizer; the central processing system acquires the information from the mobile bar code recognizer through the network controller, and sends the stock management information to the bar code recognizer; the central processing system and the network controller adopt the TCP/IP protocol for communalization; the network controller can be arranged for a plurality according to actual needs, with each network controller corresponding to one or a plurality of central processing systems.

The fright lot partitions of warehouse are arranged according to the enterprise specific conditions, namely including three areas: the through lot, the transfer lot and the permanent lot. Wherein, the through lot is provided with plant storage racks, the transfer lot with tridimensional storage racks and the permanent lot with gravity type storage racks.

The central processing system is adopted for optimizing the stock, including the optimization control upon stock balance of various goods and upon the stock time. The upper control limit and lower control limit for reasonable stock balance and stock time are set for various goods according to specific conditions of different users. The warning is automatically displayed on the condition of exceeding the control line. The setting of control line is based on an analysis of user' experience and managerial data and users of the system are allowed to make temporary amendment or permanent amendment to the control line according to their actual conditions.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A remote warehouse management system, comprising:
a central processing system; and
one or more remote data collection terminals which exchange data with the central processing system,
wherein each of the remote data collection terminals includes a wireless transceiver module which conducts wireless communication with the central processing system through a wireless base station,
wherein the central processing system includes a corresponding wireless transceiver module which receives entry-exit data of a plurality of goods delivered by the data collection terminals through the wireless base station,
wherein the central processing system generates statistics and analysis on the entry-exit data received and stores them.

2. The system of claim 1, wherein the central processing system includes a real-time stock database, a stock optimization database, a data statistics unit, a data comparison and analysis unit, a data storage and output unit, a manual input device, and a central control unit,
the data statistics unit acquiring the entry-exit data of the plurality of goods collected by the data collection terminals, reading corresponding data in the real-time stock database and making statistics and calculation, acquiring stock balance data, entry-exit time data and characteristic data of the plurality of goods and sending these data into the real-time stock database for storage through the data storage and output unit,
the data comparison and analysis unit reading the stock balance data, the entry-exit time data and the characteristic data of the plurality of goods in the real-time stock database, reading optimization program and optimization parameters in the stock optimization database and conducting optimization calculation based on these data, generating a stock excess signal within a timeframe if the stock balance of any of the plurality of goods is above an upper limit of optimal stock balance, generating a stock shortage signal within a timeframe if the stock balance of any of the plurality of goods is below a lower limit of optimal stock balance, generating a stock time warning signal if the stock time of any of the plurality of goods reaches a warning amount, and storing these signals in the stock optimization database and generating warning display through the data storage and output unit,
the data storage and output unit receiving data from the data statistics unit, the data comparison and analysis unit and the manual input device and sending these data into the real-time stock database and the stock optimization database for storage, reading data of the real-time stock database and the stock optimization database according to instructions from the data statistics unit, the data comparison and analysis unit and the manual input device and displaying these data, and
the central control unit controlling the coordination among the data statistics unit, the data comparison and analysis unit, the data storage and output unit and the manual input unit.

3. The system of claim 2, wherein the central control system includes a categorical database and a freight space allocation unit for stock partition management,
the categorical database managing storage capacity of goods partitions and freight lot occupying data of the warehouse, and
the freight space allocation unit reading the storage capacity data of goods partition and goods occupying data according to the characteristic data of the entry-exit goods and allocating fright spaces for the entered goods in related partition.

4. The system of claim 3, wherein each of the remote data collection terminals collects information of goods of entry or exit and sends the collected goods information to the central processing system, wherein the central processing system, supported by the categorical database and the real-time stock database, confirms deposit areas of the entered goods, allocates the fright lot for storage, sends the goods storage instruction to an operating personnel or an auto-transmitter, and records the entered goods data into the real-time stock database when goods enter the warehouse, confirms the freight lot for goods according to a mode of “first-in first-out”, and sends the goods withdrawal instruction to the operating personnel or the auto-transmitter, records the exited goods data sent from the remote data collection terminals of exit-entry goods in the real-time stock database when goods exit from the warehouse.

5. The system of claim 4, wherein each of the data collection terminals includes a mobile or fixed bar code recognizer to collect data of the plurality of goods.

6. The system of claim 5, wherein the remote data collection terminals communicate with the central processing system using either wired or wireless mode.

7. The system of claim 6, wherein each of the remote data collection terminals includes a network controller, which communicates with the central processing system and the bar code recognizer through either wired or wireless mode, transfers information sent by the central processing system to the bar code recognizer and transfers information collected by the bar code recognizer to the central processing system.

8. The system of claim 7, wherein the network controller includes a wired network connection port.

9. The system of claim 8, wherein the central processing system acquires information from the mobile bar code recognizer and sends stock management information to the bar code recognizer.

10. The system of claim 9, wherein the central processing system and the network controller adopt the TCP/IP protocol for communalization.

11. The system of claim 2, wherein each of the data collection terminals includes a mobile or fixed bar code recognizer to collect data of the plurality of goods.

12. The system of claim 11, wherein the remote data collection terminals communicate with the central processing system using either wired or wireless mode.

13. The system of claim 12, wherein each of the remote data collection terminals includes a network controller, which communicates with the central processing system and the bar code recognizer through either wired or wireless mode, transfers information sent by the central processing system to the bar code recognizer and transfers information collected by the bar code recognizer to the central processing system.

14. The system of claim 13, wherein the network controller includes a wired network connection port.

15. The system of claim 14, wherein the central processing system acquires information from the mobile bar code recognizer and sends stock management information to the bar code recognizer.

16. The system of claim 15, wherein the central processing system and the network controller adopt the TCP/IP protocol for communalization.
